(19) United States
(12) Patent Application Publication
(10) Pub. No.: US 2026/0246979 A1
(43) Pub. Date: Aug. 20, 2026

(54) Enhancements On Supplemental Enhancement Information Signalling In Video Bitstreams

(71) Applicant: Bytedance Inc., Los Angeles, CA (US)

(72) Inventor: Ye-Kui WANG, San Diego, CA (US)

(21) Appl. No.: 19/644,915

(22) Filed: Apr. 10, 2026

Related U.S. Application Data
(63) Continuation of application No. PCT/US2024/050554, filed on Oct. 9, 2024.
(60) Provisional application No. 63/589,720, filed on Oct. 12, 2023.

(51) Int. Cl. H04N 19/70

(52) U.S. Cl. CPC H04N 19/70

(57) ABSTRACT

A mechanism for processing video data is disclosed. The mechanism includes determining one or more bytes of data from a supplemental enhancement information (SEI) raw byte sequence payload (RBSP) header, wherein the SEI RBSP header is included in an SEI RBSP before one or more SEI messages carried in the SEI RBSP. A conversion is performed between a visual media data and a bitstream based on the SEI RBSP header.

### CROSS-REFERENCE TO RELATED APPLICATION

This is a continuation of International Patent Application No. PCT/US2024/050554, filed on Oct. 9, 2024, which claims the priority to and benefits of U.S. Provisional Patent Application 63/589,720, filed on Oct. 12, 2023. All the aforementioned patent application are hereby incorporated by reference in their entireties.

### TECHNICAL FIELD

This patent document relates to generation, storage, and consumption of digital audio video media information in a file format.

### BACKGROUND

Digital video accounts for the largest bandwidth used on the Internet and other digital communication networks. As the number of connected user devices capable of receiving and displaying video increases, the bandwidth demand for digital video usage is likely to continue to grow.

### SUMMARY

A first aspect relates to a method for processing video data comprising: determining one or more bytes of data from a supplemental enhancement information (SEI) raw byte sequence payload (RBSP) header, wherein the SEI RBSP header is included in an SEI RBSP before one or more SEI messages carried in the SEI RBSP; and performing a conversion between a visual media data and a bitstream based on the SEI RBSP header.

A second aspect relates to an apparatus for processing video data comprising: a processor; and a non-transitory memory with instructions thereon, wherein the instructions upon execution by the processor, cause the processor to perform any of the preceding aspects.

A third aspect relates to non-transitory computer readable medium comprising a computer program product for use by a video coding device, the computer program product comprising computer executable instructions stored on the non-transitory computer readable medium such that when executed by a processor cause the video coding device to perform the method of any of the preceding aspects.

A fourth aspect relates to a non-transitory computer-readable recording medium storing a bitstream of a video which is generated by a method performed by a video processing apparatus, wherein the method comprises: determining one or more bytes of data from a supplemental enhancement information (SEI) raw byte sequence payload (RBSP) header, wherein the SEI RBSP header is included in an SEI RBSP before one or more SEI messages carried in the SEI RBSP; and generating a bitstream based on the determining.

A fifth aspect relates to a method for storing bitstream of a video comprising: determining one or more bytes of data from a supplemental enhancement information (SEI) raw byte sequence payload (RBSP) header containing, wherein the SEI RBSP header is included in an SEI RBSP before one or more SEI messages carried in the SEI RBSP; generating a bitstream based on the determining; and storing the bitstream in a non-transitory computer-readable recording medium.

For the purpose of clarity, any one of the foregoing embodiments may be combined with any one or more of the other foregoing embodiments to create a new embodiment within the scope of the present disclosure.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a block diagram showing an example video processing system.

FIG. 2 is a block diagram of an example video processing apparatus.

FIG. 3 is a flowchart for an example method of video processing.

FIG. 4 is a block diagram that illustrates an example video coding system.

FIG. 5 is a block diagram that illustrates an example encoder.

FIG. 6 is a block diagram that illustrates an example decoder.

FIG. 7 is a schematic diagram of an example encoder.

### DETAILED DESCRIPTION

It should be understood at the outset that although an illustrative implementation of one or more embodiments are provided below, the disclosed systems and/or methods may be implemented using any number of techniques, whether currently known or yet to be developed. The disclosure should in no way be limited to the illustrative implementations, drawings, and techniques illustrated below, including the exemplary designs and implementations illustrated and described herein, but may be modified within the scope of the appended claims along with their full scope of equivalents.

Section headings are used in the present document for ease of understanding and do not limit the applicability of techniques and embodiments disclosed in each section only to that section. Furthermore, H.266 terminology is used in some description only for ease of understanding and not for limiting scope of the disclosed techniques. As such, the techniques described herein are applicable to other video codec protocols and designs also. In the present document, editing changes are shown to text by using “/* *\” indicating cancelled text and “{{ }}” indicating added text, with respect to the Versatile Video Coding (VVC) specification and/or the SEI messages for coded video bitstreams (VSEI) standard.

### 1. Initial Discussion

This document is related to image/video coding technologies. Specifically, this disclosure is related to enhancements on signalling of supplemental enhancement information (SEI) in video bitstreams. The ideas may be applied individually or in various combinations, for video bitstreams coded by any codec, e.g., the VVC standard, the high efficiency video coding (HEVC) standard, the advanced video coding (AVC) standard, or other standards.

### 2. Abbreviations

adaptation parameter set (APS), access unit (AU), coded layer video sequence (CLVS), coded layer video sequence start (CLVSS), cyclic redundancy check (CRC), coded video sequence (CVS), finite impulse response (FIR), intra random access point (IRAP), network abstraction layer (NAL), picture parameter set (PPS), picture unit (PU), random access skipped leading (RASL) picture, raw byte sequence payload (RBSP), supplemental enhancement information (SEI), step-wise temporal sublayer access (STSA), video coding layer (VCL), versatile supplemental enhancement information as described in Rec. ITU-T H.274|ISO/IEC 23002-7 (VSEI), video usability information (VUI), versatile video coding as described in Rec. ITU-T H.266|ISO/IEC 23090-3 (VVC)

### 3. Further Discussion

### 3.1 Video Coding Standards

Video coding standards have evolved primarily through the development of International Telecommunication Union (ITU) telecommunication standardization sector (ITU-T) and International Organization for Standardization (ISO)/International Electrotechnical Commission (IEC) standards. The ITU-T produced H.261 and H.263, ISO/IEC produced motion picture experts group (MPEG)-1 and MPEG-4 Visual, and the two organizations jointly produced the H.262/MPEG-2 Video, H.264/MPEG-4 Advanced Video Coding (AVC), and H.265/high efficiency video coding (HEVC) [1] standards. Since H.262, the video coding standards are based on the hybrid video coding structure wherein temporal prediction plus transform coding are utilized. The Versatile Video Coding (VVC) standard (ITU-T H.266|ISO/IEC 23090-3) [2] and the associated Versatile Supplemental Enhancement Information for coded video bitstreams (VSEI) standard (ITU-T H.274|ISO/IEC 23002-7) [3] are designed for use in a maximally broad range of applications, including both the simple uses such as television broadcast, video conferencing, or playback from storage media, and also more advanced use cases such as adaptive bit rate streaming, video region extraction, composition and merging of content from multiple coded video bitstreams, multiview video, scalable layered coding, and viewport-adaptive 360° immersive media.

### 3.2 SEI Messages in General and in VVC, HEVC, and AVC

SEI messages assist in processes related to decoding, display or other purposes. However, SEI messages are not required for constructing the luma or chroma samples by the decoding process. Conforming decoders are not required to process this information for output order conformance. Some SEI messages are required for checking bitstream conformance and for output timing decoder conformance. Other SEI messages are not required for check bitstream conformance.

The syntax and semantics for SEI message payloads are specified in Annex D (of VVC, HEVC, and AVC) and in ITU-T H.274|ISO/IEC 23002-7.

In VVC, HEVC, and AVC, an SEI message includes some syntax elements before the SEI payload and the SEI payload. For simplicity, the syntax elements before the SEI payload in an SEI message are referred to as SEI message header (SMH). One or more SEI messages are contained in an SEI NAL unit. Each NAL unit includes a NAL unit header followed by the RBSP syntax for the particular type of NAL unit.

In VVC and HEVC, two NAL unit types are specified for SEI NAL units, one for prefix SEI NAL units, and one for suffix SEI NAL units. The NAL unit types (NUT) in VVC for prefix and suffix SEI NAL units are the values 23 and 24 (of nal_unit_type), respectively, and named prefix NAL unit type (PREFIX_SEI_NUT) and suffix SEI NAL unit type (SUFFIX_SEI_NUT), respectively. The NAL unit types in HEVC for prefix and suffix SEI NAL units are the values 39 and 40 (of nal_unit_type), respectively, and also named PREFIX_SEI_NUT and SUFFIX_SEI_NUT, respectively.

In AVC, there is only one NAL unit type specified for SEI NAL units. The NAL unit in VVC for SEI NAL units is the value 6 (of nal_unit_type), not named.

The SEI RBSP syntax and semantics are as follows (same for VVC, HEVC, and AVC):

Descriptor

```
sei_rbsp( ) {
  Do
    sei_message( )
  while( more_rbsp_data( ) )
  rbsp_trailing_bits( )
}
```

Supplemental enhancement information (SEI) contains information that is not necessary to decode the samples of coded pictures from VCL NAL units. An SEI RBSP contains one or more SEI messages.

The general SEI message syntax and semantics in VVC are as follows (technically the same but editorially slightly differently in HEVC and AVC):

| | Descriptor |
|---|---|
| sei_message( ) { | |
| payloadType = 0 | |
| do { | |
| payload_type_byte | u(8) |
| payloadType += payload_type_byte | |
| } while( payload_type_byte = = 0xFF ) | |
| payloadSize = 0 | |
| do { | |
| payload_size_byte | u(8) |
| payloadSize += payload_size_byte | |
| } while( payload_size_byte = = 0xFF ) | |
| sei_payload( payloadType, payloadSize ) | |
| } | |

Each SEI message consists of the variables specifying the type payloadType and size payloadSize of the SEI message payload. SEI message payloads are specified in Annex D. The derived SEI message payload size payloadSize is specified in bytes and shall be equal to the number of RBSP bytes in the SEI message payload.

NOTE—The NAL unit byte sequence containing the SEI message might include one or more emulation prevention bytes (represented by emulation prevention_three_byte syntax elements). Since the payload size of an SEI message is specified in RBSP bytes, the quantity of emulation prevention bytes is not included in the size payloadSize of an SEI payload.

payload_type_byte is a byte of the payload type of an SEI message.

payload_size_byte is a byte of the payload size of an SEI message.

### 3.3 Signalling of SEI Messages of Large Sizes

Joint Video Exploration Team (JVET)-AF0148-v1 (publicly available herein: https://www.jvet-experts.org/doc_end_user/documents/32_Hannover/wg11/JVET-AF0148-v1.zip) proposes a complementary approach suitable for large SEI messages such that the number of bits used to signal the SEI payload size can be significantly saved for SEI messages of large sizes. For example, it is said that a large SEI message containing 64 kB of data in its payload would require 256 Bytes for signalling the payload size.

The proposed general SEI message syntax and semantics are as follows:

| | Descriptor |
|---|---|
| lsei_message( ) { | |
| lsei_position | u(2) |
| lsei_relevance | u(2) |
| lsei_reserved | u(4) |
| lsei_payload_type_byte | u(8) |
| lsei_payload_size_16bits | u(16) |
| lsei_payload( lseiPayloadType, lseiPayloadSize ) | |
| } | |

Each Large SEI message consists of the variables specifying the type payloadType and size payloadSize of the large SEI message payload. Large SEI message payloads are specified in Annex D. The derived Large SEI message payload size payloadSize is specified in bytes and shall be equal to the number of RBSP bytes in the Large SEI message payload.

NOTE—The NAL unit byte sequence containing the Large SEI message might include one or more emulation prevention bytes (represented by emulation_prevention_three_byte syntax elements). Since the payload size of a Large SEI message is specified in RBSP bytes, the quantity of emulation prevention bytes is not included in the size payloadSize of a Large SEI payload.

lsei_position indicates if the SEI message corresponds to the PREFIX_SEI_NUT and SUFFIX_SEI_NUT. lsei_position equal 0 indicates that the SEI message is treated as PREFIX_SEI_NUT. lsei position equal 1 indicates that the SEI message is treated as SUFFIX_SEI_NUT. Values 3 and 4 of lsei position are reserved for future use and shall be ignored.

lsei_relevance indicates the relevance of the SEI message for the target application. Isei_relevance ranges from 0 to 3, 0 being the least relevant and 3 being the most relevant.

NOTE—The relevance of an SEI message is an arbitrary decision and its use is to be specified by the target application.

lsei_reserved is revered for future use and shall be ignored.

lsei_payload_type_byte is a byte of the payload type of a large SEI message. payloadType=lsei_payload_type_byte.

payload_size_16bits is the payload size in bits of a large SEI message. payloadSize=payload_size_16bits.

### 3.4 Application-Required SEI NAL Units

JVET-AF0149-v1 (publicly available herein: https://www.jvet-experts.org/doc_end_user/documents/32_Hannover/wg11/JVET-AF0149-v1.zip) proposes a method to signal the SEI messages required to be maintained in the bitstream by an application. The method involves the definition, for VVC, of a new NAL unit type, for which the value of nal_unit_type is equal to 26 (and named REQ_SEI_NUT), with the following semantics: When a REQ_SEI_NUT NAL unit is present, the immediately following PREFIX_SEI_NUT or SUFFIX_SEI_NUT is considered as essential for the application.

### 4. Technical Problems Solved by Disclosed Technical Solutions

An example design for signalling of SEI messages has the following problems:

First, the approach in JVET-AF0148-v1 does not support SEI messages with payload sizes greater than 64 kilobyte (KB).

Second, in JVET-AF0149-v1, when a REQ_SEI_NUT NAL unit is present, the immediately following PREFIX_SEI_NUT or SUFFIX_SEI_NUT is considered as essential for the application. However, that does not make sense, as it requires carriage of one or more SEI messages (in the SEI NAL unit with nal_unit_type equal to REQ_SEI_NUT) to just indicate that the immediately following SEI NAL unit with nal_unit_type equal to PREFIX_SEI_NUT or SUFFIX_SEI_NUT is considered as essential (or necessary) for the application.

### 5. A Listing of Solutions and Embodiments

To solve the above-described problems, methods as summarized below are disclosed. The aspects should be considered as examples to explain the general concepts and should not be interpreted in a narrow way. Furthermore, these examples can be applied individually or combined in any manner.
1) In one example, one or more bytes of data is included in an SEI RBSP before one or more SEI messages carried in the SEI RBSP. For convenience, the one or more bytes of data is referred to as the SEI RBSP header.
   a. In one example, the SEI RBSP header includes information that applies to all SEI messages carried in the SEI RBSP (i.e., all SEI messages carried in the SEI NAL unit).
      i. Alternatively, in one example, the SEI RBSP header includes information that applies to at least one SEI message carried in the SEI NAL unit.
   b. In one example, the SEI RBSP header includes an indication of whether all SEI messages carried in the SEI NAL unit are considered, e.g., by the encoder or the content provider, as essential (or necessary), e.g., for the application.
      i. Alternatively, in one example, the SEI RBSP header includes an indication of whether all SEI message carried in the SEI NAL unit may be considered, e.g., by the encoder or the content provider, as essential (or necessary), e.g., for the application.
      ii. Alternatively, in one example, the SEI RBSP header includes an indication of whether at least one SEI message carried in the SEI NAL unit is considered, e.g., by the encoder or the content provider, as essential (or necessary), e.g., for the application.
      iii. Alternatively, in one example, the SEI RBSP header includes an indication of whether at least one SEI message carried in the SEI NAL unit may be considered, e.g., by the encoder or the content provider, as essential (or necessary), e.g., for the application.
      iv. In one example, the indication is a one-bit flag, with a first value (e.g., 1) indicating that SEI messages contained in the SEI RBSP are considered as necessary, and a second value (e.g., 0) indicating that SEI messages contained in the SEI RBSP are not considered as necessary.
      v. In one example, the indication is a two-bit syntax element, with a first value indicating that SEI messages contained in the SEI RBSP are considered as necessary, a second value indicating that SEI messages contained in the SEI RBSP are considered as unnecessary, and a third value indicating that the necessity of the SEI messages contained in the SEI RBSP is undetermined.
   c. In one example, the SEI RBSP header includes an indication of whether the SEI NAL unit is a prefix SEI NAL unit or a suffix SEI NAL unit.
      i. In one example, it is specified that, a prefix SEI NAL unit shall precede the first of all VCL NAL units associated with the SEI NAL unit, same as an SEI NAL unit with nal_unit_type equal to PREFIX_SEI_NUT in VVC or HEVC.
      ii. In one example, it is specified that, a suffix SEI NAL unit shall follow the last of all VCL NAL units associated with the SEI NAL unit, same as an SEI NAL unit with nal_unit_type equal to SUFFIX_SEI_NUT in VVC or HEVC.
   d. In one example, the SEI RBSP header includes a type-length indication that indicates the length, in bits, of the SEI payload type syntax element (e.g., named payload_type) for each SEI message contained in the SEI NAL unit.
      i. In one example, the type-length indication is a one-bit flag.
         1. In one example, the one-bit flag equal to 0 indicates the length being 8 bits, and the one-bit flag equal to 1 indicates the length being 16 bits.
         2. In one example, the one-bit flag equal to 0 indicates the length being 8 bits, and the one-bit flag equal to 1 indicates the length being 10 bits.
      ii. In one example, the type-length indication is a two-bit syntax element.
         1. In one example, the two-bit syntax element is disallowed to be equal to 0 (and consequently there is always at least one of the two bits being equal to 1).
      iii. In one example, the type-length indication is an N-bit syntax element, with N being an integer greater than 2.
   e. In one example, the SEI RBSP header includes a size-length indication that indicates the length, in bits, of the SEI payload size syntax element (e.g., named payload_size) for each SEI message contained in the SEI NAL unit.
      i. In one example, the size-length indication is a two-bit syntax element.
         1. In one example, the two-bit syntax element equal to 0, 1, 2, and 3 indicate the length being 8, 16, 24, and 32 bits, respectively.
         2. In one example, the two-bit syntax element equal to 0, 1, 2, and 3 indicate the length being 4, 8, 16, and 24 bits, respectively.
         3. In one example, the two-bit syntax element is disallowed to be equal to 0 (and consequently there is always at least one of the two bits being equal to 1).
         a. In one example, the two-bit syntax element equal to 1, 2, and 3 indicate the length being 8, 16, and 24 bits, respectively.
         b. In one example, the two-bit syntax element equal to 1, 2, and 3 indicate the length being 8, 16, and 32 bits, respectively.
      ii. In one example, the size-length indication is an N-bit syntax element, with N being an integer greater than 2.
         1. In one example, the N-bit syntax element is disallowed to be equal to 0 (and consequently there is always at least one of the three bits being equal to 1).
   f. In one example, the SEI RBSP header includes one or more reserved bits.
      i. In one example, the one or more reserved are all equal to 0.
      ii. In one example, the one or more reserved are all equal to 1.
      iii. In one example, one of the one or more reserved bits is equal to 1 and the rest of the one or more reserved bits are equal to 0.
      iv. In one example, the reserved bits are before the type-length indication and the size-length indication.
      v. In one example, the reserved bits are after the type-length indication and the size-length indication.
   g. In one example, the SEI RBSP header always includes at least one bit that is equal to 1.
2) In one example, in the SEI message header (that contains one or more bytes of data before the SEI payload in an SEI message), the syntax element indicating the SEI payload type, e.g., named payload_type, is u (v)-coded and the length of the syntax element, in bits, is indicated by the type-length indication in the SEI RBSP header.
3) In one example, in the SEI message header, the syntax element indicating the SEI payload size, e.g., named payload_size, is u (v)-coded and the length of the syntax element, in bits, is indicated by the size-length indication in the SEI RBSP header.
4) In one example, the type-length indication is included in the SEI message header instead of in the SEI RBSP header, and in the SEI message header the syntax element indicating the SEI payload type, e.g., named payload_size, is u (v)-coded and the length of the syntax element, in bits, is indicated by the type-length indication in the SEI message header.
5) In one example, the size-length indication is included in the SEI message header instead of in the SEI RBSP header, and in the SEI message header the syntax element indicating the SEI payload size, e.g., named payload_size, is u (v)-coded and the length of the syntax element, in bits, is indicated by the size-length indication in the SEI message header.
6) In one example, no type-length indication is included in the SEI message header and no type-length indication is included in the SEI RBSP header, and in the SEI message header the syntax element indicating the SEI payload type, e.g., named payload_type, is ue(v)-coded.
7) In one example, no size-length indication is included in the SEI message header and no size-length indication is included in the SEI RBSP header, and in the SEI message header the syntax element indicating the SEI payload size, e.g., named payload_size, is ue(v)-coded.
8) In one example, in the SEI message header, after the syntax element indicating the SEI payload type, e.g., named payload_type, and the syntax element indicating the SEI payload size, e.g., named payload_size, there is a byte alignment check followed by byte alignment bits equal to 0 until it is byte aligned.
9) In one example, for VVC, a new NAL unit type, e.g., with the value 26 for nal_unit_type, e.g., named NEW_SEI_NUT, is specified for SEI NAL units containing an SEI RBSP with the SEI RBSP header and/or the SEI message header as specified in one of the methods described above.
   a. Alternatively, in one example, for VVC, two new NAL unit types, e.g., with the values 26 and 27 for nal_unit_type, e.g., named PREFIX_NEW_SEI_NUT and SUFFIX_NEW_SEI_NUT, are specified to for SEI NAL units containing an SEI RBSP with the SEI RBSP syntax and the SEI message syntax currently specified in VVC.
      i. In one example, it is specified that an SEI NAL unit with nal_unit_type equal to PREFIX_NEW_SEI_NUT shall be a prefix SEI NAL unit (same as an SEI NAL unit with nal_unit_type equal to PREFIX_SEI_NUT) and the SEI messages in the SEI NAL unit are considered e.g., by the encoder or the content provider, as essential (or necessary), e.g., for the application.
      ii. In one example, it is specified that an SEI NAL unit with nal_unit_type equal to SUFFIX_NEW_SEI_NUT shall be a suffix SEI NAL unit (same as an SEI NAL unit with nal_unit_type equal to SUFFIX_SEI_NUT) and the SEI messages in the SEI NAL unit are considered e.g., by the encoder or the content provider, as essential (or necessary), e.g., for the application.
10) In one example, for HEVC, a new NAL unit type, e.g., with the value 41 for nal_unit_type, e.g., named NEW_SEI_NUT, is specified to for SEI NAL units containing an SEI RBSP with the SEI RBSP header and/or the SEI message header as specified in one of the methods described above.
   a. Alternatively, in one example, for HEVC, two new NAL unit types, e.g., with the values 41 and 42 for nal_unit_type, e.g., named PREFIX_NEW_SEI_NUT and SUFFIX_NEW_SEI_NUT, are specified to for SEI NAL units containing an SEI RBSP with the SEI RBSP syntax and the SEI message syntax currently specified in HEVC.
      i. In one example, it is specified that an SEI NAL unit with nal_unit_type equal to PREFIX_NEW_SEI_NUT shall be a prefix SEI NAL unit (same as an SEI NAL unit with nal_unit_type equal to PREFIX_SEI_NUT) and the SEI messages in the SEI NAL unit are considered e.g., by the encoder or the content provider, as essential (or necessary), e.g., for the application.
      ii. In one example, it is specified that an SEI NAL unit with nal_unit_type equal to SUFFIX_NEW_SEI_NUT shall be a suffix SEI NAL unit (same as an SEI NAL unit with nal_unit_type equal to SUFFIX_SEI_NUT) and the SEI messages in the SEI NAL unit are considered e.g., by the encoder or the content provider, as essential (or necessary), e.g., for the application.
11) In one example, for AVC, a new NAL unit type, e.g., with the value 17 for nal_unit_type, e.g., named NEW_SEI_NUT, is specified to for SEI NAL units containing an SEI RBSP with the SEI RBSP header and/or the SEI message header as specified in one of the methods described above.
12) In one example, for a new video coding standard other than VVC, HEVC, and AVC, a particular NAL unit type value for nal_unit_type, e.g., named SEI_NUT, is specified to for SEI NAL units containing an SEI RBSP with the SEI RBSP header and/or the SEI message header as specified in one of the methods described above, and no other NAL unit types for SEI NAL units are specified.
13) In one example, an indication included in a Realtime Transport Protocol (RTP) packet payload structure for indicating that the SEI messages contained in one or more particular SEI NAL units contained in the RTP packet are considered, e.g., by the sender or the content provider, as essential (or necessary), e.g., for the application.

### 6. Embodiments

Below are some example embodiments for the aspects summarized above in Section 5.

Most relevant parts that have been added or modified are in “{{ }}”, and some of the deleted parts are in “/* *\”. There may be some other changes that are editorial in nature and thus not indicated.

However, in embodiments other than embodiment 1, all texts are new, and they are not highlighted.

The first embodiment is for the specification of the new NAL unit type.

Other embodiments are for the SEI RBSP syntax, which includes the SEI RBSP header, and the SEI message syntax, which includes the SEI message header.

### 6.1 Embodiment 1

This embodiment is for the specification of the new NAL unit type.

TABLE 5
NAL unit type codes and NAL unit type classes

| | | | NAL unit |
|---|---|---|---|
| nal_unit_type | Name of nal_unit_type | Content of NAL unit and RBSP syntax structure | type class |
| 0 | TRAIL_NUT | Coded slice of a trailing picture or subpicture* | VCL |
| | | slice_layer_rbsp( ) | |
| . . . | . . . | . . . | . . . |
| 23 | PREFIX_SEI_NUT | Supplemental enhancement information | non-VCL |
| 24 | SUFFIX_SEI_NUT | sei_rbsp( ) | |
| 25 | FD_NUT | Filler data | non-VCL |
| | | filler_data_rbsp( ) | |
| /* 26 | RSV_NVCL_26 | Reserved non-VCL NAL unit types | non-VCL *\ |
| /* 27 | RSV_NVCL_27_ *\ | | |
| {{ 26 | NEW_SEI_NUT | Supplemental enhancement information | non-VCL }} |
| | | sei_v2_rbsp( ) | |
| {{ 27 | RSV_NVCL_27 | Reserved non-VCL NAL unit type | non-VCL }} |
| 28. . .31 | UNSPEC_28_ . . . | Unspecified non-VCL NAL unit types | non-VCL |
| | UNSPEC_31 | | |

*indicates a property of a picture when pps_mixed_nalu_types_in_pic_flag is equal to 0 and a property of the subpicture when pps_mixed_nalu_types_in_pic_flag is equal to 1.

### 6.2 Embodiment 2

In this embodiment, the SEI RBSP header is of one byte, the SEI message header contains only two syntax elements for the payload type and payload size, and the lengths of both the payload type and the payload size fields are always integer times of bytes.

| | Descriptor |
|---|---|
| sei_v2_rbsp( ) { | |
| sei_necessary_flag | u(1) |
| sei_prefix_or_suffix_flag | u(1) |
| sei_reserved_one_3bits | u(3) |
| sei_payload_type_len_flag /* 8 or 16 bits */ | u(1) |
| sei_payload_size_len /* 8, 16, 24, or 32 bits */ | u(2) |
| do | |
| sei_v2_message( ) | |
| while( more_rbsp_data( ) ) | |
| rbsp_trailing_bits( ) | |
| } | |

Supplemental enhancement information (SEI) contains information that is not necessary to decode the samples of coded pictures from VCL NAL units. An SEI RBSP contains one or more SEI messages.
sei_necessary_flag equal to 1 indicates that SEI messages contained in the SEI RBSP are considered as necessary. sei_necessary_flag equal to 0 indicates that SEI messages contained in the SEI RBSP are not considered as necessary.
sei_prefix_or_suffix_flag equal to 1 indicates that the SEI NAL unit containing the SEI RBSP is a prefix SEI NAL unit that shall precede the first of all VCL NAL units associated with the SEI NAL unit. sei_prefix_or_suffix_flag equal to 0 indicates that the SEI NAL unit containing the SEI RBSP is a suffix SEI NAL unit that shall follow the last of all VCL NAL units associated with the SEI NAL unit.
sei_reserved_one_3bits shall be equal to 7 in bitstreams conforming to this version of this Specification. The values less than 7 for sei_reserved_one_3bits are reserved for future use by ITU-T|ISO/IEC. Decoders shall also allow values less than 7 for sei_reserved_one_3bits to appear in the bitstream and shall ignore the value of sei_reserved_one_3bits.
sei_payload_type_len_flag specifies the length of the payload_type syntax element in the sei_v2_message( ) syntax structures containined in the SEI RBSP. The length of the payload_type syntax element is equal to (1+sei_payload_type_len_flag)*8 bits.
sei_payload_size_len specifies the length of the payload_size syntax element in the sei_v2_message( ) syntax structures containined in the SEI RBSP. The length of the payload_size syntax element is equal to (1+sei_payload_size_len)*8 bits.

| | Descriptor |
|---|---|
| sei_v2_message( ) { | |
| payload_type | u(v) |
| payload_size | u(v) |
| sei_payload(payload_type, payload_size ) | |
| } | |

Each SEI message consists of the variables specifying the type payloadType (which is set equal to payload_type) and size payloadSize (which is set equal to payload_size) of the SEI message payload. SEI message payloads are specified in Annex D or in VSEI. The derived SEI message payload size payloadSize is specified in bytes and shall be equal to the number of RBSP bytes in the SEI message payload.
NOTE—The NAL unit byte sequence containing the SEI message might include one or more emulation prevention bytes (represented by emulation_prevention_three_byte syntax elements). Since the payload size of an SEI message is specified in RBSP bytes, the quantity of emulation prevention bytes is not included in the size payloadSize of an SEI payload.
   payload_type specifies the payload type of the SEI message. The length of the payload_type syntax element is (1+sei_payload_type_len_flag)*8 bits.
   payload_size specifies the payload size, in bytes, of an SEI message. The length of the payload_size syntax element is (1+sei_payload_size_len)*8 bits.

### 6.3 Embodiment 3

In this embodiment, the SEI RBSP header is of one byte, the SEI message header contains only two syntax elements for the payload type and payload size, and one or both of the lengths of the payload type and the payload size fields are not always integer times of bytes, thus byte alignment syntax after the payload size field in the SEI message syntax.

| | Descriptor |
|---|---|
| sei_v2_rbsp( ) { | |
| sei_necessary_flag | u(1) |
| sei_prefix_or_suffix_flag | u(1) |
| sei_payload_type_len_plus1 /* 6, 8, or 10 bits */ | u(2) |
| sei_payload_size_len /* 4, 8, 16, or 24 bits */ /* Alternatively, 8, 16, 24, or 32 bits */ | u(2) |
| sei_reserved_zero_2bits | u(2) |
| do | |
| sei_v2_message( ) | |
| while( more_rbsp_data( ) ) | |
| rbsp_trailing_bits( ) | |
| } | |

Supplemental enhancement information (SEI) contains information that is not necessary to decode the samples of coded pictures from VCL NAL units. An SEI RBSP contains one or more SEI messages.
sei_necessary_flag equal to 1 indicates that SEI messages contained in the SEI RBSP are considered as necessary. sei_necessary_flag equal to 0 indicates that SEI messages contained in the SEI RBSP are not considered as necessary.
sei_prefix_or_suffix_flag equal to 1 indicates that the SEI NAL unit containing the SEI RBSP is a prefix SEI NAL unit that shall precede the first of all VCL NAL units associated with the SEI NAL unit. sei_prefix_or_suffix_flag equal to 0 indicates that the SEI NAL unit containing the SEI RBSP is a suffix SEI NAL unit that shall follow the last of all VCL NAL units associated with the SEI NAL unit.
sei_payload_type_len_plus1 specifies the length of the payload_type syntax element in the sei_v2_message( ) syntax structures containined in the SEI RBSP. The value of sei_payload_type_len plus1 shall not be equal to 0. The length of the payload_type syntax element is equal to sei_payload_type_len plus1*2+4 bits.
sei_payload_size_len specifies the length of the payload_size syntax element in the sei_v2_message( ) syntax structures containined in the SEI RBSP.
The variable PayloadSizeLen is set equal to (1+sei_payload_size_len)*8.
Alternatively, the variable PayloadSizeLen is set equal to 1) 4 when sei_payload_size_len is equal to 0, 2) 8 when sei_payload_size_len is equal to 1, 3) 16 when sei_payload_size_len is equal to 2, and 4) 24 when sei_payload_size_len is equal to 3.
sei_reserved_zero_2bits shall be equal to 0 in bitstreams conforming to this version of this Specification. The values greater than 0 for sei_reserved_zero_2bits are reserved for future use by ITU-T|ISO/IEC. Decoders shall also allow values greater than 0 for sei_reserved_zero_2bits to appear in the bitstream and shall ignore the value of sei_reserved_zero_2bits.

| | Descriptor |
|---|---|
| sei_v2_message( ) { | |
| payload_type | u(v) |
| payload_size | u(v) |
| while( !byte_aligned( ) ) | |
| byte_alignment_bit_equal_to_one /* equal to 1 */ | f(1) |
| sei_payload(payload_type, payload_size ) | |
| } | |

Each SEI message consists of the variables specifying the type payloadType (which is set equal to payload_type) and size payloadSize (which is set equal to payload_size) of the SEI message payload. SEI message payloads are specified in Annex D or in VSEI. The derived SEI message payload size payloadSize is specified in bytes and shall be equal to the number of RBSP bytes in the SEI message payload.
NOTE—The NAL unit byte sequence containing the SEI message might include one or more emulation prevention bytes (represented by emulation prevention_three_byte syntax elements). Since the payload size of an SEI message is specified in RBSP bytes, the quantity of emulation prevention bytes is not included in the size payloadSize of an SEI payload.
   payload_type specifies the payload type of the SEI message. The length of the payload_type syntax element is sei_payload_type_len_plus1*2+4 bits.
   payload_size specifies the payload size, in bytes, of an SEI message. The length of the payload_size syntax element is PayloadSizeLen bits.

### 6.4 Embodiment 4

In this embodiment, the SEI RBSP header is of one byte, the SEI message header contains one byte in addition to the two syntax elements for the payload type and payload size, the SEI RBSP header always has at least one bit equal to 1, and the lengths of both the payload type and the payload size fields are always integer times of bytes.

| | Descriptor |
|---|---|
| sei_v2_rbsp( ) { | |
| sei_necessary_flag | u(1) |
| sei_prefix_or_suffix_flag | u(1) |
| sei_bit_equal_to_one | f(1) |
| sei_rbsp_reserved_zero_5bits | u(5) |
| do | |
| sei_v2_message( ) | |
| while( more_rbsp_data( ) ) | |
| rbsp_trailing_bits( ) | |
| } | |

Supplemental enhancement information (SEI) contains information that is not necessary to decode the samples of coded pictures from VCL NAL units. An SEI RBSP contains one or more SEI messages.
sei_necessary_flag equal to 1 indicates that SEI messages contained in the SEI RBSP are considered as necessary. sei_necessary_flag equal to 0 indicates that SEI messages contained in the SEI RBSP are not considered as necessary.
sei_prefix_or_suffix_flag equal to 1 indicates that the SEI NAL unit containing the SEI RBSP is a prefix SEI NAL unit that shall precede the first of all VCL NAL units associated with the SEI NAL unit. sei_prefix_or_suffix_flag equal to 0 indicates that the SEI NAL unit containing the SEI RBSP is a suffix SEI NAL unit that shall follow the last of all VCL NAL units associated with the SEI NAL unit.
sei_bit_equal_to_one shall be equal to 1.
sei_rbsp_reserved_zero_5bits shall be equal to 0 in bitstreams conforming to this version of this Specification. The values greater than 0 for sei_rbsp_reserved_zero_5bits are reserved for future use by ITU-T|ISO/IEC. Decoders shall also allow values greater than 0 for sei_rbsp_reserved_zero_5bits to appear in the bitstream and shall ignore the value of sei_rbsp_reserved_zero_5bits.

| | Descriptor |
|---|---|
| sei_v2_message( ) { | |
| sei_msg_reserved_zero_5bits | u(5) |
| sei_payload_type_len_flag /* 8 or 16 bits */ | u(1) |
| sei_payload_size_len /*8, 16, 24, or 32 bits */ | u(2) |
| payload_type | u(v) |
| payload_size | u(v) |
| sei_payload(payload_type, payload_size ) | |
| } | |

Each SEI message consists of the variables specifying the type payloadType (which is set equal to payload_type) and size payloadSize (which is set equal to payload_size) of the SEI message payload. SEI message payloads are specified in Annex D or in VSEI. The derived SEI message payload size payloadSize is specified in bytes and shall be equal to the number of RBSP bytes in the SEI message payload.
NOTE—The NAL unit byte sequence containing the SEI message might include one or more emulation prevention bytes (represented by emulation_prevention_three_byte syntax elements). Since the payload size of an SEI message is specified in RBSP bytes, the quantity of emulation prevention bytes is not included in the size payloadSize of an SEI payload.
   sei_msg_reserved_zero_5bits shall be equal to 0 in bitstreams conforming to this version of this Specification. The values greater than 0 for sei_msg_reserved_zero_5bits are reserved for future use by ITU-T|ISO/IEC. Decoders shall also allow values greater than 0 for sei_msg_reserved_zero_5bits to appear in the bitstream and shall ignore the value of sei_msg_reserved_zero_5bits.
   sei_payload_type_len_flag specifies the length of the payload_type syntax element in the sei_v2_message( ) syntax structure. The length of the payload_type syntax element is equal to (1+sei_payload_type_len_flag)*8 bits. sei_payload_size_len specifies the length of the payload_size syntax element in the sei_v2_message( ) syntax structure. The length of the payload_size syntax element is equal to (1+sei_payload_size_len)*8 bits.
   payload_type specifies the payload type of the SEI message. The length of the payload_type syntax element is (1+sei_payload_type_len_flag)*8 bits.
   payload_size specifies the payload size, in bytes, of an SEI message. The length of the payload_size syntax element is (1+sei_payload_size_len)*8 bits.

### 6.5 Embodiment 5

One or more bytes of SEI RBSP header with one bit always equal to 1, one or bytes of SEI message header, one or both of the lengths of the payload type and the payload size fields are not always integer times of bytes, thus byte alignment syntax after the payload size field in the SEI message syntax. The semantics are similarly as above.

| | Descriptor |
|---|---|
| sei_v2_rbsp( ) { | |
| sei_necessary_flag | u(1) |
| sei_prefix_or_suffix_flag | u(1) |
| sei_bit_equal_to_one | u(1) |
| sei_reserved_zero_5bits | u(5) |
| do | |
| sei_v2_message( ) | |
| while( more_rbsp_data( ) ) | |
| rbsp_trailing_bits( ) | |
| } | |

| | Descriptor |
|---|---|
| sei_v2_message( ) { | |
| sei_reserved_zero_5bits | u(5) |
| sei_payload_type_len_flag /* 8 or 10 bits */ | u(1) |
| sei_payload_size_len /* 4, 8, 16, or 24 bits */ /* Alternatively, 8, 16, 24, or 32 bits */ | u(2) |
| payload_type | u(v) |
| payload_size | u(v) |
| while( !byte_aligned( ) ) | |
| byte_alignment_bit_equal_to_one /* equal to 1 */ | f(1) |
| sei_payload( payload_type, payload_size ) | |
| } | |

### 6.6 Embodiment 6

One or more bytes of SEI RBSP header without one bit always equal to 1, one or bytes of SEI message header, the lengths of both the payload type and the payload size fields are always integer times of bytes. The semantics are similarly as above.

| | Descriptor |
|---|---|
| sei_v2_rbsp( ) { | |
| sei_necessary_flag | u(1) |
| sei_prefix_or_suffix_flag | u(1) |
| sei_reserved_zero_6bits | u(6) |
| do | |
| sei_v2_message( ) | |
| while( more_rbsp_data( ) ) | |
| rbsp_trailing_bits( ) | |
| } | |

| | Descriptor |
|---|---|
| sei_v2_message( ) { | |
| sei_reserved_zero_5bits | u(5) |
| sei_payload_type_len_flag /* 8 or 16 bits */ | u(1) |
| sei_payload_size_len /*8, 16, 24, or 32 bits */ | u(2) |
| payload_type | u(v) |
| payload_size | u(v) |
| sei_payload( payload_type, payload_size ) | |
| } | |

### 6.7 Embodiment 7

One or more bytes of SEI RBSP header without one bit always equal to 1, one or bytes of SEI message header, one or both of the lengths of the payload type and the payload size fields are not always integer times of bytes, thus byte alignment syntax after the payload size field in the SEI message syntax. The semantics are similarly as above.

| | Descriptor |
|---|---|
| sei_v2_rbsp( ) { | |
| sei_necessary_flag | u(1) |
| sei_prefix_or_suffix_flag | u(1) |
| sei_reserved_zero_6bits | u(6) |
| do | |
| sei_v2_message( ) | |
| while( more_rbsp_data( ) ) | |
| rbsp_trailing_bits( ) | |
| } | |

| | Descriptor |
|---|---|
| sei_v2_message( ) { | |
| sei_reserved_zero_5bits | u(5) |
| sei_payload_type_len_flag /* 8 or 10 bits */ | u(1) |
| sei_payload_size_len /* 4, 8, 16, or 24 bits */ /* Alternatively, 8, 16, 24, or 32 bits */ | u(2) |
| payload_type | u(v) |
| payload_size | u(v) |
| while( !byte_aligned( ) ) | |
| byte_alignment_bit_equal_to_one /* equal to 1 */ | f(1) |
| sei_payload(payload_type, payload_size ) | |
| } | |

### 6.8 Embodiment 8

One or more bytes of SEI RBSP header, with or without one bit always equal to 1, zero bytes of SEI message header, ue(v)-coded payload type and payload size fields, byte alignment syntax after the payload size field in the SEI message syntax. The semantics are similarly as above.

| | Descriptor |
|---|---|
| sei_v2_rbsp( ) { | |
| sei_necessary_flag | u(1) |
| sei_prefix_or_suffix_flag | u(1) |
| sei_reserved_zero_6bits | u(6) |
| do | |
| sei_v2_message( ) | |
| while( more_rbsp_data( ) ) | |
| rbsp_trailing_bits( ) | |
| } | |

| | Descriptor |
|---|---|
| sei_v2_message( ) { | |
| payload_type | ue(v) |
| payload_size | ue(v) |
| while( !byte_aligned( ) ) | |
| byte_alignment_bit_equal_to_one /* equal to 1 */ | f(1) |
| sei_payload(payload_type, payload_size ) | |
| } | |

### 6.9 Embodiment 9

One or more bytes of SEI RBSP header, with or without one bit always equal to 1, one or more bytes of SEI message header, ue(v)-coded payload type and payload size fields, byte alignment syntax after the payload size field in the SEI message syntax. The semantics are similarly as above.

| | Descriptor |
|---|---|
| sei_v2_rbsp( ) { | |
| sei_necessary_flag | u(1) |
| sei_prefix_or_suffix_flag | u(1) |
| sei_reserved_zero_6bits | u(6) |
| do | |
| sei_v2_message( ) | |
| while( more_rbsp_data( ) ) | |
| rbsp_trailing_bits( ) | |
| } | |

| | Descriptor |
|---|---|
| sei_v2_message( ) { | |
| sei_reserved_zero_8bits | u(8) |
| payload_type | ue(v) |
| payload_size | ue(v) |
| while( !byte_aligned( ) ) | |
| byte_alignment_bit_equal_to_one /* equal to 1 */ | f(1) |
| sei_payload(payload_type, payload_size ) | |
| } | |

### 7. REFERENCES

[1] ITU-T and ISO/IEC, “High efficiency video coding”, Rec. ITU-T H.265|ISO/IEC 23008-2 (in force edition).
[2] ITU-T and ISO/IEC, “Versatile Video Coding”, Rec. ITU-T H.266|ISO/IEC 23090-3.
[3] ITU-T and ISO/IEC, “Versatile Supplemental Enhancement Information Messages for Coded Video Bitstreams”, Rec. ITU-T Rec. H.274|ISO/IEC 23002-7.

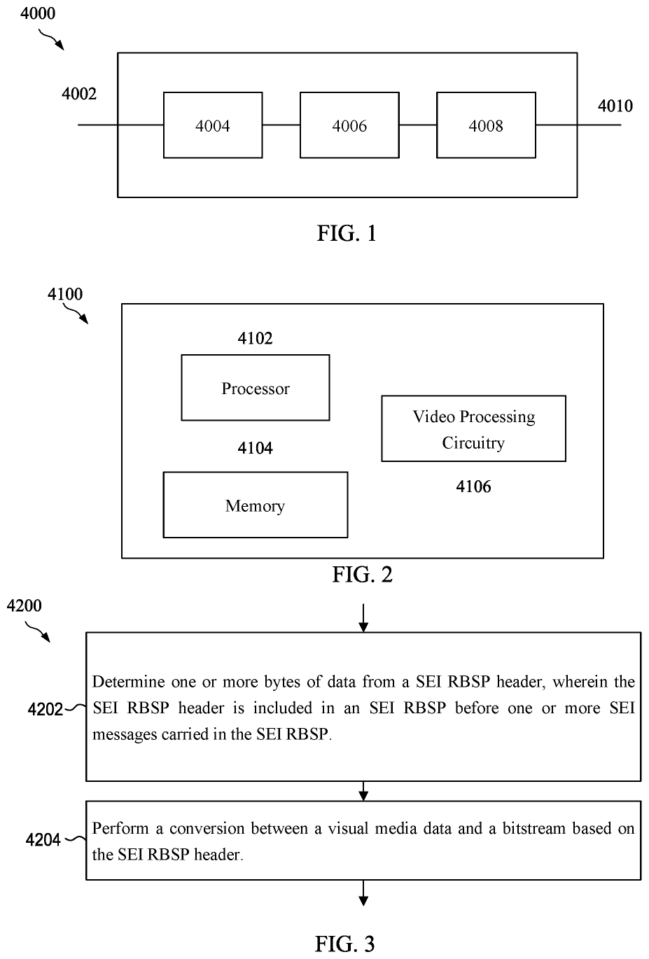

FIG. 1 is a block diagram showing an example video processing system 4000 in which various techniques disclosed herein may be implemented. Various implementations may include some or all of the components of the system 4000. The system 4000 may include input 4002 for receiving video content. The video content may be received in a raw or uncompressed format, e.g., 8 or 10 bit multi-component pixel values, or may be in a compressed or encoded format. The input 4002 may represent a network interface, a peripheral bus interface, or a storage interface. Examples of network interface include wired interfaces such as Ethernet, passive optical network (PON), etc. and wireless interfaces such as Wi-Fi or cellular interfaces.

The system 4000 may include a coding component 4004 that may implement the various coding or encoding methods described in the present document. The coding component 4004 may reduce the average bitrate of video from the input 4002 to the output of the coding component 4004 to produce a coded representation of the video. The coding techniques are therefore sometimes called video compression or video transcoding techniques. The output of the coding component 4004 may be either stored, or transmitted via a communication connected, as represented by the component 4006. The stored or communicated bitstream (or coded) representation of the video received at the input 4002 may be used by a component 4008 for generating pixel values or displayable video that is sent to a display interface 4010. The process of generating user-viewable video from the bitstream representation is sometimes called video decompression. Furthermore, while certain video processing operations are referred to as “coding” operations or tools, it will be appreciated that the coding tools or operations are used at an encoder and corresponding decoding tools or operations that reverse the results of the coding will be performed by a decoder.

Examples of a peripheral bus interface or a display interface may include universal serial bus (USB) or high definition multimedia interface (HDMI) or Displayport, and so on. Examples of storage interfaces include serial advanced technology attachment (SATA), peripheral component interconnect (PCI), integrated drive electronics (IDE) interface, and the like. The techniques described in the present document may be embodied in various electronic devices such as mobile phones, laptops, smartphones or other devices that are capable of performing digital data processing and/or video display.

FIG. 2 is a block diagram of an example video processing apparatus 4100. The apparatus 4100 may be used to implement one or more of the methods described herein. The apparatus 4100 may be embodied in a smartphone, tablet, computer, Internet of Things (IoT) receiver, and so on. The apparatus 4100 may include one or more processors 4102, one or more memories 4104 and video processing circuitry 4106. The processor(s) 4102 may be configured to implement one or more methods described in the present document. The memory (memories) 4104 may be used for storing data and code used for implementing the methods and techniques described herein. The video processing circuitry 4106 may be used to implement, in hardware circuitry, some techniques described in the present document. In some embodiments, the video processing circuitry 4106 may be at least partly included in the processor 4102, e.g., a graphics co-processor.

FIG. 3 is a flowchart for an example method 4200 of video processing. The method 4200 determines one or more bytes of data from a supplemental enhancement information (SEI) raw byte sequence payload (RBSP) header, wherein the SEI RBSP header is included in an SEI RBSP before one or more SEI messages carried in the SEI RBSP at step 4202. A conversion between a visual media data and a bitstream is performed based on the SEI RBSP header at step 4204. The conversion may include encoding at an encoder, decoding at a decoder, or combinations thereof.

It should be noted that the method 4200 can be implemented in an apparatus for processing video data comprising a processor and a non-transitory memory with instructions thereon, such as video encoder 4400, video decoder 4500, and/or encoder 4600. In such a case, the instructions upon execution by the processor, cause the processor to perform the method 4200. Further, the method 4200 can be performed by a non-transitory computer readable medium comprising a computer program product for use by a video coding device. The computer program product comprises computer executable instructions stored on the non-transitory computer readable medium such that when executed by a processor cause the video coding device to perform the method 4200.

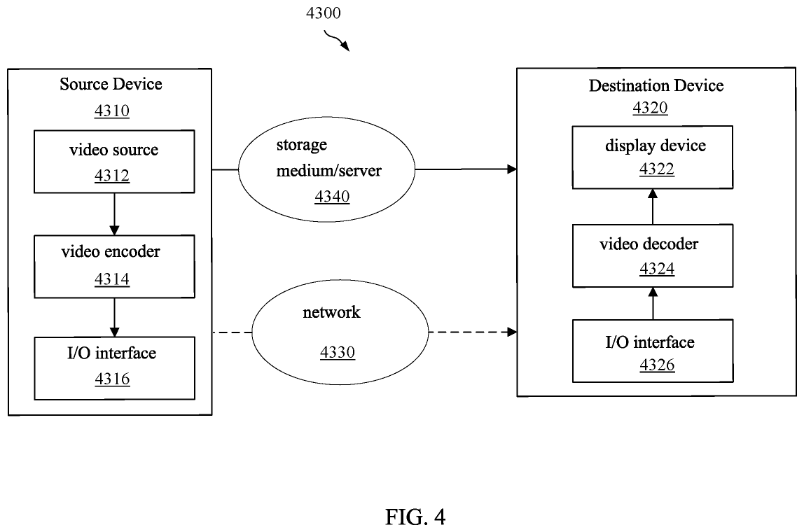

FIG. 4 is a block diagram that illustrates an example video coding system 4300 that may utilize the techniques of this disclosure. The video coding system 4300 may include a source device 4310 and a destination device 4320. Source device 4310 generates encoded video data which may be referred to as a video encoding device. Destination device 4320 may decode the encoded video data generated by source device 4310 which may be referred to as a video decoding device.

Source device 4310 may include a video source 4312, a video encoder 4314, and an input/output (I/O) interface 4316. Video source 4312 may include a source such as a video capture device, an interface to receive video data from a video content provider, and/or a computer graphics system for generating video data, or a combination of such sources. The video data may comprise one or more pictures. Video encoder 4314 encodes the video data from video source 4312 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. I/O interface 4316 may include a modulator/demodulator (modem) and/or a transmitter. The encoded video data may be transmitted directly to destination device 4320 via I/O interface 4316 through network 4330. The encoded video data may also be stored onto a storage medium/server 4340 for access by destination device 4320.

Destination device 4320 may include an I/O interface 4326, a video decoder 4324, and a display device 4322. I/O interface 4326 may include a receiver and/or a modem. I/O interface 4326 may acquire encoded video data from the source device 4310 or the storage medium/server 4340. Video decoder 4324 may decode the encoded video data. Display device 4322 may display the decoded video data to a user. Display device 4322 may be integrated with the destination device 4320, or may be external to destination device 4320, which can be configured to interface with an external display device.

Video encoder 4314 and video decoder 4324 may operate according to a video compression standard, such as the High Efficiency Video Coding (HEVC) standard, Versatile Video Coding (VVC) standard and other current and/or further standards.

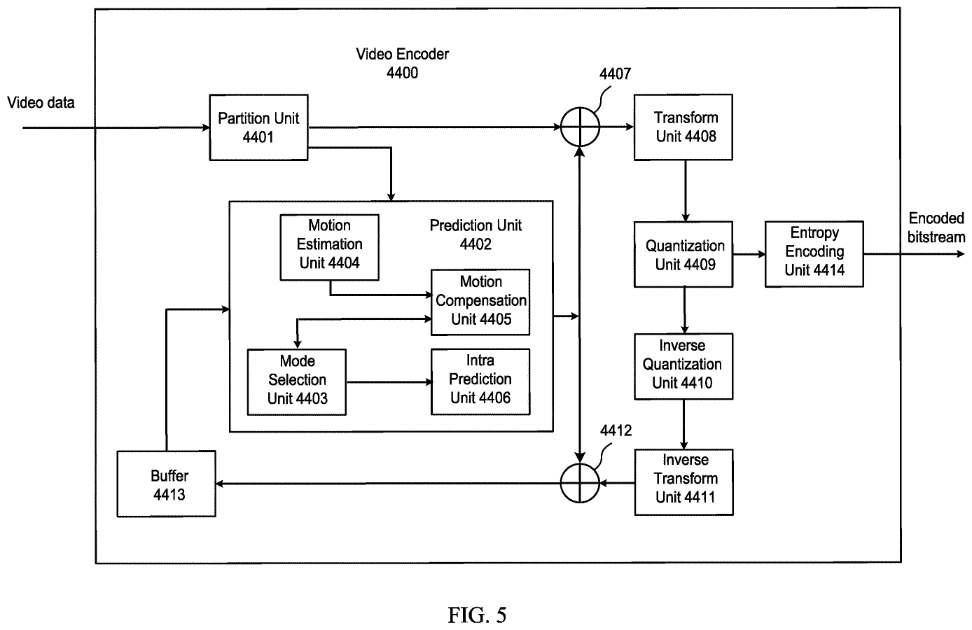

FIG. 5 is a block diagram illustrating an example of video encoder 4400, which may be video encoder 4314 in the system 4300 illustrated in FIG. 4. Video encoder 4400 may be configured to perform any or all of the techniques of this disclosure. The video encoder 4400 includes a plurality of functional components. The techniques described in this disclosure may be shared among the various components of video encoder 4400. In some examples, a processor may be configured to perform any or all of the techniques described in this disclosure.

The functional components of video encoder 4400 may include a partition unit 4401, a prediction unit 4402 which may include a mode select unit 4403, a motion estimation unit 4404, a motion compensation unit 4405, an intra prediction unit 4406, a residual generation unit 4407, a transform processing unit 4408, a quantization unit 4409, an inverse quantization unit 4410, an inverse transform unit 4411, a reconstruction unit 4412, a buffer 4413, and an entropy encoding unit 4414.

In other examples, video encoder 4400 may include more, fewer, or different functional components. In an example, prediction unit 4402 may include an intra block copy (IBC) unit. The IBC unit may perform prediction in an IBC mode in which at least one reference picture is a picture where the current video block is located.

Furthermore, some components, such as motion estimation unit 4404 and motion compensation unit 4405 may be highly integrated, but are represented in the example of video encoder 4400 separately for purposes of explanation.

Partition unit 4401 may partition a picture into one or more video blocks. Video encoder 4400 and video decoder 4500 may support various video block sizes.

Mode select unit 4403 may select one of the coding modes, intra or inter, e.g., based on error results, and provide the resulting intra or inter coded block to a residual generation unit 4407 to generate residual block data and to a reconstruction unit 4412 to reconstruct the encoded block for use as a reference picture. In some examples, mode select unit 4403 may select a combination of intra and inter prediction (CIIP) mode in which the prediction is based on an inter prediction signal and an intra prediction signal. Mode select unit 4403 may also select a resolution for a motion vector (e.g., a sub-pixel or integer pixel precision) for the block in the case of inter prediction.

To perform inter prediction on a current video block, motion estimation unit 4404 may generate motion information for the current video block by comparing one or more reference frames from buffer 4413 to the current video block. Motion compensation unit 4405 may determine a predicted video block for the current video block based on the motion information and decoded samples of pictures from buffer 4413 other than the picture associated with the current video block.

Motion estimation unit 4404 and motion compensation unit 4405 may perform different operations for a current video block, for example, depending on whether the current video block is in an I slice, a P slice, or a B slice.

In some examples, motion estimation unit 4404 may perform uni-directional prediction for the current video block, and motion estimation unit 4404 may search reference pictures of list 0 or list 1 for a reference video block for the current video block. Motion estimation unit 4404 may then generate a reference index that indicates the reference picture in list 0 or list 1 that contains the reference video block and a motion vector that indicates a spatial displacement between the current video block and the reference video block. Motion estimation unit 4404 may output the reference index, a prediction direction indicator, and the motion vector as the motion information of the current video block. Motion compensation unit 4405 may generate the predicted video block of the current block based on the reference video block indicated by the motion information of the current video block.

In other examples, motion estimation unit 4404 may perform bi-directional prediction for the current video block, motion estimation unit 4404 may search the reference pictures in list 0 for a reference video block for the current video block and may also search the reference pictures in list 1 for another reference video block for the current video block. Motion estimation unit 4404 may then generate reference indexes that indicate the reference pictures in list 0 and list 1 containing the reference video blocks and motion vectors that indicate spatial displacements between the reference video blocks and the current video block. Motion estimation unit 4404 may output the reference indexes and the motion vectors of the current video block as the motion information of the current video block. Motion compensation unit 4405 may generate the predicted video block of the current video block based on the reference video blocks indicated by the motion information of the current video block.

In some examples, motion estimation unit 4404 may output a full set of motion information for decoding processing of a decoder. In some examples, motion estimation unit 4404 may not output a full set of motion information for the current video. Rather, motion estimation unit 4404 may signal the motion information of the current video block with reference to the motion information of another video block. For example, motion estimation unit 4404 may determine that the motion information of the current video block is sufficiently similar to the motion information of a neighboring video block.

In one example, motion estimation unit 4404 may indicate, in a syntax structure associated with the current video block, a value that indicates to the video decoder 4500 that the current video block has the same motion information as another video block.

In another example, motion estimation unit 4404 may identify, in a syntax structure associated with the current video block, another video block and a motion vector difference (MVD). The motion vector difference indicates a difference between the motion vector of the current video block and the motion vector of the indicated video block. The video decoder 4500 may use the motion vector of the indicated video block and the motion vector difference to determine the motion vector of the current video block.

As discussed above, video encoder 4400 may predictively signal the motion vector. Two examples of predictive signaling techniques that may be implemented by video encoder 4400 include advanced motion vector prediction (AMVP) and merge mode signaling.

Intra prediction unit 4406 may perform intra prediction on the current video block. When intra prediction unit 4406 performs intra prediction on the current video block, intra prediction unit 4406 may generate prediction data for the current video block based on decoded samples of other video blocks in the same picture. The prediction data for the current video block may include a predicted video block and various syntax elements.

Residual generation unit 4407 may generate residual data for the current video block by subtracting the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and residual generation unit 4407 may not perform the subtracting operation.

Transform processing unit 4408 may generate one or more transform coefficient video blocks for the current video block by applying one or more transforms to a residual video block associated with the current video block.

After transform processing unit 4408 generates a transform coefficient video block associated with the current video block, quantization unit 4409 may quantize the transform coefficient video block associated with the current video block based on one or more quantization parameter (QP) values associated with the current video block.

Inverse quantization unit 4410 and inverse transform unit 4411 may apply inverse quantization and inverse transforms to the transform coefficient video block, respectively, to reconstruct a residual video block from the transform coefficient video block. Reconstruction unit 4412 may add the reconstructed residual video block to corresponding samples from one or more predicted video blocks generated by the prediction unit 4402 to produce a reconstructed video block associated with the current block for storage in the buffer 4413.

After reconstruction unit 4412 reconstructs the video block, the loop filtering operation may be performed to reduce video blocking artifacts in the video block.

Entropy encoding unit 4414 may receive data from other functional components of the video encoder 4400. When entropy encoding unit 4414 receives the data, entropy encoding unit 4414 may perform one or more entropy encoding operations to generate entropy encoded data and output a bitstream that includes the entropy encoded data.

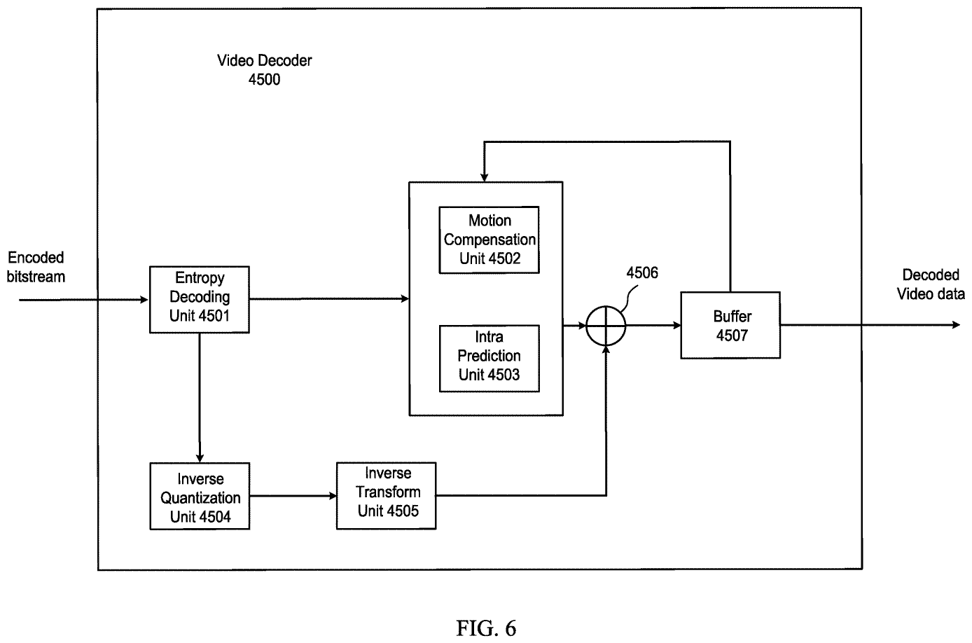

FIG. 6 is a block diagram illustrating an example of video decoder 4500 which may be video decoder 4324 in the system 4300 illustrated in FIG. 4. The video decoder 4500 may be configured to perform any or all of the techniques of this disclosure. In the example shown, the video decoder 4500 includes a plurality of functional components. The techniques described in this disclosure may be shared among the various components of the video decoder 4500. In some examples, a processor may be configured to perform any or all of the techniques described in this disclosure.

In the example shown, video decoder 4500 includes an entropy decoding unit 4501, a motion compensation unit 4502, an intra prediction unit 4503, an inverse quantization unit 4504, an inverse transformation unit 4505, a reconstruction unit 4506, and a buffer 4507. Video decoder 4500 may, in some examples, perform a decoding pass generally reciprocal to the encoding pass described with respect to video encoder 4400.

Entropy decoding unit 4501 may retrieve an encoded bitstream. The encoded bitstream may include entropy coded video data (e.g., encoded blocks of video data). Entropy decoding unit 4501 may decode the entropy coded video data, and from the entropy decoded video data, motion compensation unit 4502 may determine motion information including motion vectors, motion vector precision, reference picture list indexes, and other motion information. Motion compensation unit 4502 may, for example, determine such information by performing the AMVP and merge mode.

Motion compensation unit 4502 may produce motion compensated blocks, possibly performing interpolation based on interpolation filters. Identifiers for interpolation filters to be used with sub-pixel precision may be included in the syntax elements.

Motion compensation unit 4502 may use interpolation filters as used by video encoder 4400 during encoding of the video block to calculate interpolated values for sub-integer pixels of a reference block. Motion compensation unit 4502 may determine the interpolation filters used by video encoder 4400 according to received syntax information and use the interpolation filters to produce predictive blocks.

Motion compensation unit 4502 may use some of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter coded block, and other information to decode the encoded video sequence.

Intra prediction unit 4503 may use intra prediction modes for example received in the bitstream to form a prediction block from spatially adjacent blocks. Inverse quantization unit 4504 inverse quantizes, i.e., de-quantizes, the quantized video block coefficients provided in the bitstream and decoded by entropy decoding unit 4501. Inverse transform unit 4505 applies an inverse transform.

Reconstruction unit 4506 may sum the residual blocks with the corresponding prediction blocks generated by motion compensation unit 4502 or intra prediction unit 4503 to form decoded blocks. If desired, a deblocking filter may also be applied to filter the decoded blocks in order to remove blockiness artifacts. The decoded video blocks are then stored in buffer 4507, which provides reference blocks for subsequent motion compensation/intra prediction and also produces decoded video for presentation on a display device.

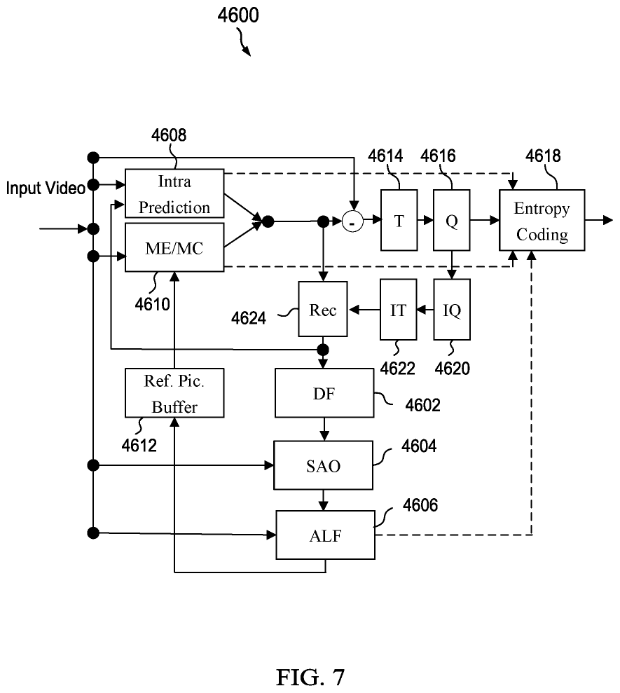

FIG. 7 is a schematic diagram of an example encoder 4600. The encoder 4600 is suitable for implementing the techniques of VVC. The encoder 4600 includes three in-loop filters, namely a deblocking filter (DF) 4602, a sample adaptive offset (SAO) 4604, and an adaptive loop filter (ALF) 4606. Unlike the DF 4602, which uses predefined filters, the SAO 4604 and the ALF 4606 utilize the original samples of the current picture to reduce the mean square errors between the original samples and the reconstructed samples by adding an offset and by applying a finite impulse response (FIR) filter, respectively, with coded side information signaling the offsets and filter coefficients. The ALF 4606 is located at the last processing stage of each picture and can be regarded as a tool trying to catch and fix artifacts created by the previous stages.

The encoder 4600 further includes an intra prediction component 4608 and a motion estimation/compensation (ME/MC) component 4610 configured to receive input video. The intra prediction component 4608 is configured to perform intra prediction, while the ME/MC component 4610 is configured to utilize reference pictures obtained from a reference picture buffer 4612 to perform inter prediction. Residual blocks from inter prediction or intra prediction are fed into a transform (T) component 4614 and a quantization (Q) component 4616 to generate quantized residual transform coefficients, which are fed into an entropy coding component 4618. The entropy coding component 4618 entropy codes the prediction results and the quantized transform coefficients and transmits the same toward a video decoder (not shown). Quantization components output from the quantization component 4616 may be fed into an inverse quantization (IQ) components 4620, an inverse transform component 4622, and a reconstruction (REC) component 4624. The REC component 4624 is able to output images to the DF 4602, the SAO 4604, and the ALF 4606 for filtering prior to those images being stored in the reference picture buffer 4612.

A listing of solutions preferred by some examples is provided next.

The following solutions show examples of techniques discussed herein.

1. A method for processing media data comprising: determining a supplemental enhancement information (SEI) raw byte sequence payload (RBSP) header containing one or more bytes of data, wherein the SEI RBSP header is included in an SEI RBSP before one or more SEI messages carried in the SEI RBSP; and performing a conversion between a visual media data and a bitstream based on the SEI RBSP header.

2. The method of solution 1, wherein the SEI RBSP header includes information that applies to all SEI messages carried in the SEI RBSP and all SEI messages carried in the SEI network abstraction layer (NAL) unit.

3. The method of any of solutions 1-2, wherein the SEI RBSP header includes information that applies to at least one SEI message carried in the SEI NAL unit.

4. The method of any of solutions 1-3, wherein the SEI RBSP header includes an indication of whether all SEI messages carried in the SEI NAL unit are considered by the encoder or the content provider, as essential or necessary, for the application.

5. The method of any of solutions 1-4, wherein the SEI RBSP header includes an indication of whether all SEI message carried in the SEI NAL unit may be considered by the encoder or the content provider, as essential or necessary, for the application.

6. The method of any of solutions 1-5, wherein the SEI RBSP header includes an indication of whether at least one SEI message carried in the SEI NAL unit is considered by the encoder or the content provider, as essential or necessary, for the application.

7. The method of any of solutions 1-6, wherein the SEI RBSP header includes an indication of whether at least one SEI message carried in the SEI NAL unit may be considered by the encoder or the content provider, as essential or necessary, for the application.

8. The method of any of solutions 1-7, wherein the indication is a one-bit flag, with a first value (e.g., 1) indicating that SEI messages contained in the SEI RBSP are considered as necessary, and a second value (e.g., 0) indicating that SEI messages contained in the SEI RBSP are not considered as necessary.

9. The method of any of solutions 1-8, wherein the indication is a two-bit syntax element, with a first value indicating that SEI messages contained in the SEI RBSP are considered as necessary, a second value indicating that SEI messages contained in the SEI RBSP are considered as unnecessary, and a third value indicating that the necessity of the SEI messages contained in the SEI RBSP is undetermined.

10. The method of any of solutions 1-9, wherein the SEI RBSP header includes an indication of whether the SEI NAL unit is a prefix SEI NAL unit or a suffix SEI NAL unit.

11. The method of any of solutions 1-10, wherein it is specified that, a prefix SEI NAL unit shall precede the first of all VCL NAL units associated with the SEI NAL unit, same as an SEI NAL unit with nal_unit_type equal to PREFIX_SEI_NUT in VVC or HEVC, or wherein it is specified that, a suffix SEI NAL unit shall follow the last of all VCL NAL units associated with the SEI NAL unit, same as an SEI NAL unit with nal_unit_type equal to SUFFIX_SEI_NUT in VVC or HEVC.

12. The method of any of solutions 1-11, wherein the SEI RBSP header includes a type-length indication that indicates the length, in bits, of the SEI payload type syntax element (e.g., named payload_type) for each SEI message contained in the SEI NAL unit.

13. The method of any of solutions 1-12, wherein the type-length indication is a one-bit flag, or wherein the one-bit flag equal to 0 indicates the length being 8 bits, and the one-bit flag equal to 0 indicates the length being 16 bits, or wherein the one-bit flag equal to 0 indicates the length being 8 bits, and the one-bit flag equal to 0 indicates the length being 10 bits.

14. The method of any of solutions 1-13, wherein the type-length indication is a two-bit syntax element, or wherein the two-bit syntax element is disallowed to be equal to 0 (and consequently there is always at least one of the two bits being equal to 1), or wherein the type-length indication is an N-bit syntax element, with N being an integer greater than 2.

15. The method of any of solutions 1-14, wherein the SEI RBSP header includes a size-length indication that indicates the length, in bits, of the SEI payload size syntax element (e.g., named payload_size) for each SEI message contained in the SEI NAL unit.

16. The method of any of solutions 1-15, wherein the type-length indication is a two-bit syntax element, or wherein the two-bit syntax element equal to 0, 1, 2, and 3 indicate the length being 8, 16, 24, and 32 bits, respectively, or wherein the two-bit syntax element equal to 0, 1, 2, and 3 indicate the length being 4, 8, 16, and 24 bits, respectively, or wherein the two-bit syntax element is disallowed to be equal to 0 (and consequently there is always at least one of the two bits being equal to 1), or wherein the two-bit syntax element equal to 1, 2, and 3 indicate the length being 8, 16, and 24 bits, respectively, or wherein the two-bit syntax element equal to 1, 2, and 3 indicate the length being 8, 16, and 32 bits, respectively.

17. The method of any of solutions 1-16, wherein the type-length indication is an N-bit syntax element, with N being an integer greater than 2, or wherein the N-bit syntax element is disallowed to be equal to 0 (and consequently there is always at least one of the three bits being equal to 1), or wherein the SEI RBSP header includes one or more reserved bits, or wherein the one or more reserved are all equal to 0, or wherein the one or more reserved are all equal to 1, or wherein one of the one or more reserved bits is equal to 1 and the rest of the one or more reserved bits are equal to 0, or wherein the reserved bits are before the type-length indication and the size-length indication, or wherein the reserved bits are after the type-length indication and the size-length indication, or wherein the SEI RBSP header always includes at least one bit that is equal to 1.

18. The method of any of solutions 1-17, wherein in the SEI message header (that contains one or more bytes of data before the SEI payload in an SEI message), the syntax element indicating the SEI payload type, e.g., named payload_type, is u (v)-coded and the length of the syntax element, in bits, is indicated by the type-length indication in the SEI RBSP header.

19. The method of any of solutions 1-18, wherein in the SEI message header, the syntax element indicating the SEI payload size, e.g., named payload_size, is u (v)-coded and the length of the syntax element, in bits, is indicated by the size-length indication in the SEI RBSP header.

20. The method of any of solutions 1-19, wherein the type-length indication is included in the SEI message header instead of in the SEI RBSP header, and in the SEI message header the syntax element indicating the SEI payload type, e.g., named payload_size, is u (v)-coded and the length of the syntax element, in bits, is indicated by the type-length indication in the SEI message header.

21. The method of any of solutions 1-20, wherein the size-length indication is included in the SEI message header instead of in the SEI RBSP header, and in the SEI message header the syntax element indicating the SEI payload size, e.g., named payload_size, is u (v)-coded and the length of the syntax element, in bits, is indicated by the type-length indication in the SEI message header.

22. The method of any of solutions 1-21, wherein no type-length indication is included in the SEI message header and no type-length indication is included in the SEI RBSP header, and in the SEI message header the syntax element indicating the SEI payload type, e.g., named payload_type, is ue(v)-coded.

23. The method of any of solutions 1-22, wherein no size-length indication is included in the SEI message header and no size-length indication is included in the SEI RBSP header, and in the SEI message header the syntax element indicating the SEI payload size, e.g., named payload_size, is ue(v)-coded.

24. The method of any of solutions 1-23, wherein in the SEI message header, after the syntax element indicating the SEI payload type, e.g., named payload_type, and the syntax element indicating the SEI payload size, e.g., named payload_size, there is a byte alignment check followed by byte alignment bits equal to 0 until it is byte aligned.

25. The method of any of solutions 1-24, wherein for VVC, a new NAL unit type, e.g., with the value 26 for nal_unit_type, e.g., named NEW_SEI_NUT, is specified for SEI NAL units containing an SEI RBSP with the SEI RBSP header and/or the SEI message header as specified in one of the methods described above.

26. The method of any of solutions 1-25, wherein for VVC, two new NAL unit types, e.g., with the values 26 and 27 for nal_unit_type, e.g., named PREFIX_NEW_SEI_NUT and SUFFIX_NEW_SEI_NUT, are specified to for SEI NAL units containing an SEI RBSP with the SEI RBSP syntax and the SEI message syntax currently specified in VVC.

27. The method of any of solutions 1-26, wherein it is specified that an SEI NAL unit with nal_unit_type equal to PREFIX_NEW_SEI_NUT shall be a prefix SEI NAL unit (same as an SEI NAL unit with nal_unit_type equal to PREFIX_SEI_NUT) and the SEI messages in the SEI NAL unit are considered e.g., by the encoder or the content provider, as essential (or necessary), e.g., for the application.

28. The method of any of solutions 1-27, wherein it is specified that an SEI NAL unit with nal_unit_type equal to SUFFIX_NEW_SEI_NUT shall be a suffix SEI NAL unit (same as an SEI NAL unit with nal_unit_type equal to SUFFIX_SEI_NUT) and the SEI messages in the SEI NAL unit are considered e.g., by the encoder or the content provider, as essential (or necessary), e.g., for the application.

29. The method of any of solutions 1-28, wherein for HEVC, a new NAL unit type, e.g., with the value 41 for nal_unit_type, e.g., named NEW_SEI_NUT, is specified to for SEI NAL units containing an SEI RBSP with the SEI RBSP header and/or the SEI message header as specified in one of the methods described above.

30. The method of any of solutions 1-29, wherein for HEVC, two new NAL unit types, e.g., with the values 41 and 42 for nal_unit_type, e.g., named PREFIX_NEW_SEI_NUT and SUFFIX_NEW_SEI_NUT, are specified to for SEI NAL units containing an SEI RBSP with the SEI RBSP syntax and the SEI message syntax currently specified in HEVC.

31. The method of any of solutions 1-30, wherein it is specified that an SEI NAL unit with nal_unit_type equal to PREFIX_NEW_SEI_NUT shall be a prefix SEI NAL unit (same as an SEI NAL unit with nal_unit_type equal to PREFIX_SEI_NUT) and the SEI messages in the SEI NAL unit are considered e.g., by the encoder or the content provider, as essential (or necessary), e.g., for the application.

32. The method of any of solutions 1-31, wherein it is specified that an SEI NAL unit with nal_unit_type equal to SUFFIX_NEW_SEI_NUT shall be a suffix SEI NAL unit (same as an SEI NAL unit with nal_unit_type equal to SUFFIX_SEI_NUT) and the SEI messages in the SEI NAL unit are considered e.g., by the encoder or the content provider, as essential (or necessary), e.g., for the application.

33. The method of any of solutions 1-32, wherein for AVC, a new NAL unit type, e.g., with the value 17 for nal_unit_type, e.g., named NEW_SEI_NUT, is specified to for SEI NAL units containing an SEI RBSP with the SEI RBSP header and/or the SEI message header as specified in one of the methods described above.

34. The method of any of solutions 1-33, wherein for a new video coding standard other than VVC, HEVC, and AVC, a particular NAL unit type value for nal_unit_type, e.g., named SEI_NUT, is specified to for SEI NAL units containing an SEI RBSP with the SEI RBSP header and/or the SEI message header as specified in one of the methods described above, and no other NAL unit types for SEI NAL units are specified.

35. The method of any of solutions 1-34, wherein an indication included in a Realtime Transport Protocol (RTP) packet payload structure for indicating that the SEI messages contained in one or more particular SEI NAL units contained in the RTP packet are considered, e.g., by the sender or the content provider, as essential (or necessary), e.g., for the application.

36. An apparatus for processing video data comprising: a processor; and a non-transitory memory with instructions thereon, wherein the instructions upon execution by the processor, cause the processor to perform the method of any of solutions 1-35.

37. A non-transitory computer readable medium comprising a computer program product for use by a video coding device, the computer program product comprising computer executable instructions stored on the non-transitory computer readable medium such that when executed by a processor cause the video coding device to perform the method of any of solutions 1-35.

38. A non-transitory computer-readable recording medium storing a bitstream of a video which is generated by a method performed by a video processing apparatus, wherein the method comprises: determining a supplemental enhancement information (SEI) raw byte sequence payload (RBSP) header containing one or more bytes of data, wherein the SEI RBSP header is included in an SEI RBSP before one or more SEI messages carried in the SEI RBSP; and generating a bitstream based on the determining.

39. A method for storing bitstream of a video comprising: determining a supplemental enhancement information (SEI) raw byte sequence payload (RBSP) header containing one or more bytes of data, wherein the SEI RBSP header is included in an SEI RBSP before one or more SEI messages carried in the SEI RBSP; generating a bitstream based on the determining; and storing the bitstream in a non-transitory computer-readable recording medium.

40. A method, apparatus, or system described in the present document.

In the solutions described herein, an encoder may conform to the format rule by producing a coded representation according to the format rule. In the solutions described herein, a decoder may use the format rule to parse syntax elements in the coded representation with the knowledge of presence and absence of syntax elements according to the format rule to produce decoded video.

In the present document, the term “video processing” may refer to video encoding, video decoding, video compression or video decompression. For example, video compression algorithms may be applied during conversion from pixel representation of a video to a corresponding bitstream representation or vice versa. The bitstream representation of a current video block may, for example, correspond to bits that are either co-located or spread in different places within the bitstream, as is defined by the syntax. For example, a macroblock may be encoded in terms of transformed and coded error residual values and also using bits in headers and other fields in the bitstream. Furthermore, during conversion, a decoder may parse a bitstream with the knowledge that some fields may be present, or absent, based on the determination, as is described in the above solutions. Similarly, an encoder may determine that certain syntax fields are or are not to be included and generate the coded representation accordingly by including or excluding the syntax fields from the coded representation.

The disclosed and other solutions, examples, embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., erasable programmable read-only memory (EPROM), electrically erasable programmable read-only memory (EEPROM), and flash memory devices; magnetic disks, e.g., internal hard disks or removable disks; magneto optical disks; and compact disc read-only memory (CD ROM) and Digital versatile disc-read only memory (DVD-ROM) disks. The processor and the memory can be supplemented by, or incorporated in, special purpose logic circuitry.

While this patent document contains many specifics, these should not be construed as limitations on the scope of any subject matter or of what may be claimed, but rather as descriptions of features that may be specific to particular embodiments of particular techniques. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

A first component is directly coupled to a second component when there are no intervening components, except for a line, a trace, or another medium between the first component and the second component. The first component is indirectly coupled to the second component when there are intervening components other than a line, a trace, or another medium between the first component and the second component. The term “coupled” and its variants include both directly coupled and indirectly coupled. The use of the term “about” means a range including ±10% of the subsequent number unless otherwise stated.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled may be directly connected or may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A method for processing media data, comprising:
performing a conversion between the media data and a bitstream according to a rule,
wherein a supplemental enhancement information (SEI) raw byte sequence payload (RBSP) header comprises one or more bytes of data, and wherein the rule specifies that the SEI RBSP header is included in an SEI RBSP before one or more SEI messages carried in the SEI RBSP.

2. The method of claim 1, wherein the SEI RBSP header includes information that applies to all SEI messages carried in the SEI RBSP or at least one SEI message carried in an SEI network abstraction layer (NAL) unit containing the SEI RBSP,
wherein the SEI RBSP header includes a first indication of whether all SEI messages carried in the SEI NAL unit are considered as essential or necessary for an application, or whether all SEI messages carried in the SEI NAL unit is allowed to be considered as essential or necessary for the application, or whether at least one SEI message carried in the SEI NAL unit is considered as essential or necessary for the application, or whether at least one SEI message carried in the SEI NAL unit is allowed to be considered as essential or necessary for the application.

3. The method of claim 2, wherein the first indication is a one-bit flag, with a first value indicating that the one or more SEI messages contained in the SEI RBSP are considered as necessary, and a second value indicating that the one or more SEI messages contained in the SEI RBSP are not considered as necessary, or
wherein the first indication is a two-bit syntax element, with a first value indicating that the one or more SEI messages contained in the SEI RBSP are considered as necessary, a second value indicating that the one or more SEI messages contained in the SEI RBSP are considered as unnecessary, and a third value indicating that the necessity of the one or more SEI messages contained in the SEI RBSP is undetermined.

4. The method of claim 1, wherein the SEI RBSP header includes a second indication of whether an SEI network abstraction layer (NAL) unit containing the SEI RBSP is a prefix SEI NAL unit or a suffix SEI NAL unit,
wherein the prefix SEI NAL unit shall precede a first of all video coding layer (VCL) NAL units associated with the SEI NAL unit, or a suffix SEI NAL unit shall follow a last of all VCL NAL units associated with the SEI NAL unit.

5. The method of claim 1, wherein the SEI RBSP header includes at least one of a type-length indication or a size-length indication,
wherein the type-length indication indicates a length, in bits, of an SEI payload type syntax element for each SEI message contained in an SEI network abstraction layer (NAL) unit containing the SEI RBSP, wherein the type-length indication is a one-bit flag, a two-bit syntax element, or an N-bit syntax element, and wherein the SEI payload type syntax element included in an SEI message header is u (v)-coded,
wherein the size-length indication indicates a length, in bits, of an SEI payload size syntax element for each SEI message contained in the SEI NAL unit containing the SEI RBSP, wherein the size-length indication is a two-bit syntax element or an N-bit syntax element, and wherein the SEI payload size syntax element included in the SEI message header is u (v)-coded,
wherein N is an integer greater than 2.

6. The method of claim 5, wherein the SEI RBSP header includes one or more reserved bits,
wherein the one or more reserved bits are all equal to 0 or 1, or wherein one of the one or more reserved bits is equal to 1 and the rest of the one or more reserved bits are equal to 0,
wherein the one or more reserved bits are before or after the type-length indication and the size-length indication, or
wherein the SEI RBSP header always includes at least one bit that is equal to 1.

7. The method of claim 1, wherein the one or more SEI messages comprise an SEI message header before SEI payload included in the one or more SEI messages, wherein the SEI message header includes at least one of a type-length indication or a size-length indication,
wherein the type-length indication indicates a length, in bits, of an SEI payload type syntax element included in the SEI message header, and wherein the SEI payload type syntax element included in the SEI message header is u (v)-coded,
wherein the size-length indication indicates a length, in bits, of an SEI payload size syntax element included in the SEI message header, and wherein the SEI payload size syntax element included in the SEI message header is u (v)-coded.

8. The method of claim 1, wherein a type-length indication is excluded from an SEI message header and the type-length indication is excluded from the SEI RBSP header, and the SEI message header includes an SEI payload type syntax element indicating an SEI payload type, wherein the SEI payload type syntax element is ue(v)-coded, or
wherein a size-length indication is excluded from the SEI message header and the size-length indication is excluded from the SEI RBSP header, and the SEI message header includes an SEI payload size syntax element indicating an SEI payload size, wherein the SEI payload size syntax element is ue(v)-coded.

9. The method of claim 1, wherein the one or more SEI messages comprise an SEI message header before SEI payload included in the one or more SEI messages, wherein the SEI message header includes a byte alignment check followed by byte alignment bits equal to 0 until the SEI message header is byte aligned, and wherein the byte alignment check and the byte alignment bits are positioned after an SEI payload type syntax element indicating an SEI payload type and an SEI payload size syntax element indicating an SEI payload size that are included in the SEI message header.

10. The method of claim 1, wherein for versatile video coding (VVC), a first network abstraction layer (NAL) unit type with a value of 26 is specified for SEI NAL units containing the SEI RBSP with the SEI RBSP header or an SEI message header.

11. The method of claim 1, wherein for versatile video coding (VVC), a second network abstraction layer (NAL) unit type with a value of 26 and a third NAL unit type with a value of 27 are specified for SEI NAL units containing the SEI RBSP with an SEI RBSP syntax and an SEI message syntax specified in VVC,
wherein an SEI NAL unit with the second NAL unit type shall be a prefix SEI NAL unit and SEI messages in the SEI NAL unit with the second NAL unit type are considered as essential or necessary for an application, or
wherein an SEI NAL unit with the third NAL unit type shall be a suffix SEI NAL unit and SEI messages in the SEI NAL unit with the third NAL unit type are considered as essential or necessary for the application.

12. The method of claim 1, wherein for high efficiency video coding (HEVC), a fourth network abstraction layer (NAL) unit type with a value of 41 is specified for SEI NAL units containing the SEI RBSP with the SEI RBSP header or an SEI message header.

13. The method of claim 1, wherein for high efficiency video coding (HEVC), a fifth network abstraction layer (NAL) unit type with a value of 41 and a sixth NAL unit type with a value of 42 are specified for SEI NAL units containing the SEI RBSP with an SEI RBSP syntax and an SEI message syntax specified in HEVC,
wherein an SEI NAL unit with the fifth NAL unit type shall be a prefix SEI NAL unit and SEI messages in the SEI NAL unit with the fifth NAL unit type are considered as essential or necessary for an application, or
wherein an SEI NAL unit with the sixth NAL unit type shall be a suffix SEI NAL unit and SEI messages in the SEI NAL unit with the sixth NAL unit type are considered as essential or necessary for the application.

14. The method of claim 1, wherein for advanced video coding (AVC), a seventh network abstraction layer (NAL) unit type with a value of 17 is specified for SEI NAL units containing the SEI RBSP with the SEI RBSP header or an SEI message header.

15. The method of claim 1, wherein for a video coding standard other than versatile video coding (VVC), high efficiency video coding (HEVC) and advanced video coding (AVC), an eighth network abstraction layer (NAL) unit type with a particular value is specified for SEI NAL units containing the SEI RBSP with the SEI RBSP header or an SEI message header, and no other NAL unit types for the SEI NAL units are specified.

16. The method of claim 1, wherein a third indication is included in a Realtime Transport Protocol (RTP) packet payload structure for indicating that the one or more SEI messages contained in one or more particular SEI network abstraction layer (NAL) units contained in the RTP packet are considered as essential or necessary for an application.

17. The method of claim 1, wherein the conversion includes encoding the media data into the bitstream.

18. The method of claim 1, wherein the conversion includes decoding the media data from the bitstream.

19. An apparatus for processing media data comprising: a processor; and a non-transitory memory with instructions thereon, wherein the instructions upon execution by the processor, cause the processor to:
perform a conversion between the media data and a bitstream according to a rule,
wherein a supplemental enhancement information (SEI) raw byte sequence payload (RBSP) header comprises one or more bytes of data, and wherein the rule specifies that the SEI RBSP header is included in an SEI RBSP before one or more SEI messages carried in the SEI RBSP.

20. A non-transitory computer-readable recording medium storing a bitstream of a video which is generated by a method performed by a video processing apparatus, wherein the method comprises:
generating the bitstream based on a rule,
wherein a supplemental enhancement information (SEI) raw byte sequence payload (RBSP) header comprises one or more bytes of data, and wherein the rule specifies that the SEI RBSP header is included in an SEI RBSP before one or more SEI messages carried in the SEI RBSP.
